(19) United States
(12) Patent Application Publication
(10) Pub. No.: US 2012/0306889 A1
(43) Pub. Date: Dec. 6, 2012

(54) METHOD AND APPARATUS FOR OBJECT-BASED TRANSITION EFFECTS FOR A USER INTERFACE

(75) Inventors: Ivan WONG, San Jose, CA (US); Jason Andalcio, Seattle, WA (US); Bipin Mathew, Seattle, WA (US)

(73) Assignee: MOTOROLA MOBILITY, INC., Libertyville, IL (US)

(21) Appl. No.: 13/118,999

(22) Filed: May 31, 2011

(51) Int. Cl. G06T 13/00

(52) U.S. Cl. 345/473

(57) ABSTRACT

A method and apparatus can provide object-based transition effects for a user interface. The method can include displaying at least one first element corresponding to a first activity on a screen of a user device. The method can include receiving a baton transition request and generating first activity baton information. The method can include displaying a first baton image corresponding to the first activity baton information and generating second activity baton information that provides visual transition information for a transition from the first activity to the second activity. The method can include transitioning the first baton image corresponding to the first activity baton information to a second image corresponding to the second activity baton information, displaying the second image corresponding to the second activity baton information, and displaying at least one second element corresponding to the second activity on the screen.

### BACKGROUND

1. Field

The present disclosure is directed to a method and apparatus for object-based transition effects for a user interface. More particularly, the present disclosure is directed to transitioning a screen element from one screen to another screen on a display of a user device.

2. Introduction

User devices used in today's society include mobile phones, personal digital assistants, portable computers, and various other electronic communication devices. Due to the hand held size of some user devices, only one activity, such as one screen for the activity, is only displayed on the user device at a time. For example, typical mobile device user interface is composed of multiple different discreet screens that are displayed at different times. A user interacts with displayed elements for a given activity. To accomplish a task, a user typically navigates across multiple screens and interacts with the elements on each screen. For example, a user uses a Contacts screen to select a person for a phone call. Then the user uses a Calling screen to make the phone call. To jump from the Contacts screen to the Calling screen, a user device system typically carries out some system-defined full-screen transitions, like cross-fades, side-swipes, and/or other full-screen transitions etc.

Unfortunately, a user may lose the context of the transition as elements from one screen may appear at a different location in the next screen after a screen transition. For example, after a user selects an element corresponding to a contact in a Contacts screen, the element may appear at a different location in the Calling screen. As another example, when the user selects an icon element corresponding to a contact in a Contacts screen as the recipient of for an email message, the user device switches from the Contacts screen to an Email Message screen, and the icon element instantly jumps from its location in the Contacts screen to another location in the Email Message screen. This jump temporarily disorients the user because it does not provide a smooth transition of the icon element from one screen to the next screen.

Thus, there is a need for a method and apparatus for object-based transition effects for a user interface.

### BRIEF DESCRIPTION OF THE DRAWINGS

In order to describe the manner in which advantages and features of the disclosure can be obtained, various embodiments will be illustrated in the appended drawings. Understanding that these drawings depict only typical embodiments of the disclosure and do not limit its scope, the disclosure will be described and explained with additional specificity and detail through the use of the drawings in which:

FIG. 1 is an example illustration of a baton sequence according to one embodiment;

FIG. 2 is an example block diagram of a user device according to one embodiment;

FIG. 3 illustrates a sample flowchart according to one embodiment;

FIG. 4 illustrates a sample flowchart according to one embodiment;

FIG. 5 is an example illustration of a baton framework according to one embodiment;

FIG. 6 is an example illustration of transition states and multi-phased baton animations according to one embodiment; and

FIG. 7 is an example illustration of a sequence signal flow diagram according to one embodiment.

### DETAILED DESCRIPTION

A method and apparatus for object-based transition effects for a user interface is disclosed. The method can include displaying at least one first element on a screen. The first element can correspond to a first activity operating in the user device. The method can include receiving a baton transition request. The method can include generating first activity baton information that provides visual transition information for a transition from the first activity to a second activity. The second activity can be configured to operate in the user device. The method can include displaying a first baton image corresponding to the first activity baton information. The method can include generating second activity baton information that provides visual transition information for a transition from the first activity to the second activity. The method can include transitioning the first baton image corresponding to the first activity baton information to a second image corresponding to the second activity baton information. The method can include displaying the second image corresponding to the second activity baton information. The method can include displaying at least one second element on the screen. The second element can correspond to the second activity operating in the user device.

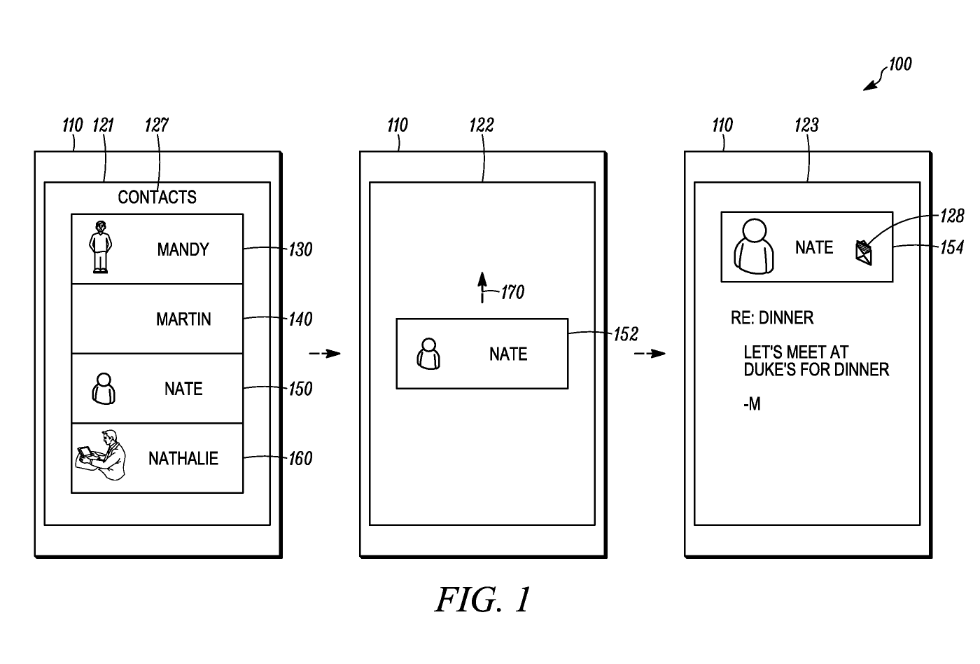

FIG. 1 is an example illustration of a baton sequence 100 according to one embodiment. The baton sequence 100 can be performed on a user device 110 displaying a first activity 121, a transition 122, and a second activity 123. The user device 110 can display a first element 127 in the first activity 121 and a second element 128 in the second activity 123. The user device 110 can display other elements 130, 140, 150, and 160 in the first activity 121. The other element 150 can be the first element and/or can be a first baton image. A “baton” is defined as visual information that maintains the context of a baton image during a transition from a first activity to a second activity. The user device 110 can display transitioning 170 the first baton image 150 in a transition 122. The transition 122 can include an animated baton image 152. The user device 110 can display a second baton image 154 in the second activity 123. The second baton image 154 can include or can be the second element 128. An activity can be an application component that provides a screen on the user device 110 with which users can interact in order to do something, such as dial the phone, take a photo, send an email, or view a map. Each activity can be given a window in which to draw its user interface. The window can fill a screen, but may be smaller than a screen and float on top of other windows. The activity's relationship to a screen can be that it can provide a Graphical User Interface (GUI) window and can handle a lifecycle of, and user interaction events of, that window for a screen to be drawn into.

For example, the user device 110 can display a first activity 121 corresponding to a contacts list for selecting at least one contact as the recipient of an email message. A user can select a first baton image 150 as the desired recipient of the email message. The user device 110 can transition 170 an image 152 corresponding to the first baton image 150 to a second baton image 154.

As a more elaborate example, initially, a user can be in an email inbox screen, such as the first activity 121, and can see a list of all the email items 130, 140, 150, and 160 kept in an inbox. Each row can contain a summary of the corresponding email, including a label and picture of the sender, an email subject, and the first few characters of the body of the email message. The user can click on an email from “Nate” by clicking on the first baton image 150 in order to go to the email detail screen. The picture and label of the Nate first baton image can animate and move 170 to the location they will have in a detailed email screen, such as the second activity 123. Similarly, other elements, such as a subject line, can move to a new location, as well as the first characters of the body. While those screen elements animate, other screen-to-screen transitions can occurs, such as fading-in/fading-out or swiping one screen to another. The transition can be complete, when both the screen-to-screen transition and the screen element transition(s) complete to the second activity 123. At this point, the user can interact with the new screen. Having the screen elements (the picture and label of Nate) animate across the screens can help to maintain the context and object of the task (communicating with Nate) even when the overall contents of the screen change. In this scenario, the picture and the label of Nate can be batons that are passed from the first activity 121 screen of an email inbox to the second activity 123 Screen of email detail.

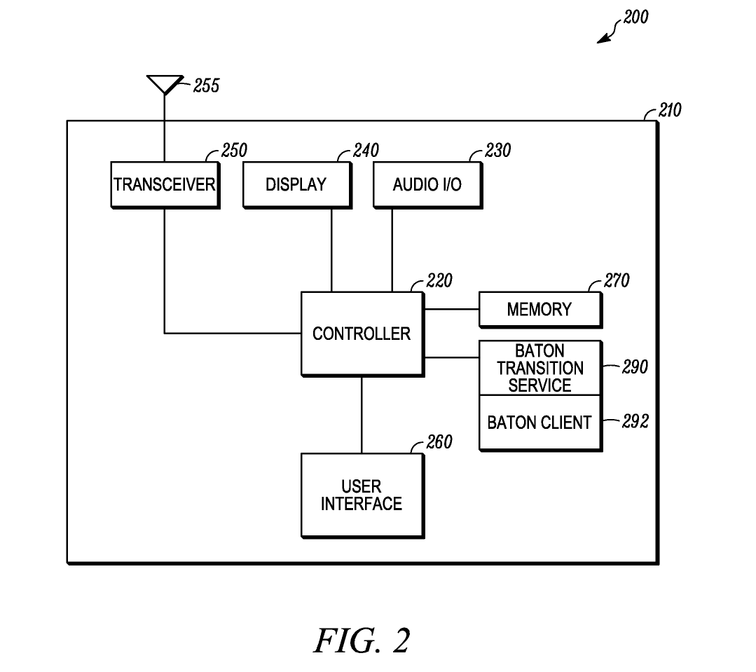

FIG. 2 is an example block diagram of a user device 200 according to one embodiment. The user device 200 may be a wireless telephone, a cellular telephone, a personal digital assistant, a pager, a personal computer, a selective call receiver, or any other device that is capable of displaying transitions between screens, such as illustrations of different activities. The user device 200 can include a housing 210, a controller 220 located within the housing 210, audio input and output circuitry 230 coupled to the controller 220, a display 240 coupled to the controller 220, a transceiver 250 coupled to the controller 220, an antenna 255 coupled to the transceiver 250, a user interface 260 coupled to the controller 220, and a memory 270 coupled to the controller 220. The user device 200 can also include a baton transition service module 290 and a baton client module 292. The baton transition service module 290 and the baton client module 292 can be coupled to the controller 220, can reside within the controller 220, can reside within the memory 270, can be autonomous modules, can be software, can be hardware, or can be in any other format useful for a module for a user device 200.

The display 240 can be a liquid crystal display (LCD), a light emitting diode (LED) display, a plasma display, a touch screen display, a projector, or any other means for displaying information. Other methods can be used to present information to a user, such as aurally through a speaker or kinesthetically through a vibrator. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, a touch screen display, or any other device useful for providing an interface between a user and an electronic device. The memory 270 can include a random access memory, a read only memory, an optical memory, a subscriber identity module memory, or any other memory that can be coupled to a user device.

In operation, the display 240 can display at least one first element. The first element can correspond to a first activity operating in the user device. The first activity can be a substantially full screen activity. The baton transition service module 290 can receive a baton transition request and generate first activity baton information that provides visual transition information for a transition from the first activity to a second activity, where the second activity can be configured to operate in the user device 200. The second activity can be a substantially full screen activity in that the majority of display may change when switching from the first activity to the second activity. For example, a small portion of the display 240 can display some constant information, such as the time of day at the top of the display 240 and/or home screen-type icons at the bottom of the display 240.

The baton transition request can include first baton image information. The first activity baton information can include information corresponding to a visual animation for the transition from the first activity to the second activity. The baton transition service module 290 can generate the first activity baton information by generating the first activity baton information based on the first baton image information. The display 240 can display a first baton image corresponding to the first activity baton information. The baton transition service module 290 can generate second activity baton information that provides visual transition information for a transition from the first activity to the second activity and can provide transition information for transitioning the first baton image corresponding to the first activity baton information to a second image corresponding to the second activity baton information. The display 240 can display the second image corresponding to the second activity baton information. The display 240 can display at least one second element, where the second element can correspond to the second activity operating in the user device 200.

The baton transition service module 290 can include or can be a baton transition service Application Programming Interface (API), can be included in the controller 220, can be hardware, can be software, or can be any other module useful on a user device. The baton transition service module 290 can provide transition information to the display 240 and the display 240 can display a transition of a baton from the first baton image to the second baton image. The baton transition service module 290 can also provide transition information to the controller 220, to a display controller, or to any other intermediate module that can be used to display a transition of a baton from the first baton image to the second baton image.

The baton transition service module 290 can retrieve a transition policy corresponding to a visual animation sequence of an image corresponding to activity baton information. For example, the transition policy can be a first transition policy corresponding to a visual animation sequence of the first image corresponding to the first activity baton information and/or can be a second transition policy corresponding to a visual animation sequence of the second image corresponding to the second activity baton information. The transition policy can be retrieved from baton transition service module storage, from user device memory 270, from a wireless service, from a user, or from any other source that can provide a transition policy corresponding to a visual animation sequence of an image corresponding to activity baton information. The baton transition service module 290 can have transition rules that specify the source activity name, the target activity name, the action for the transition, a transition animation policy class name, and/or other information useful for transition rules.

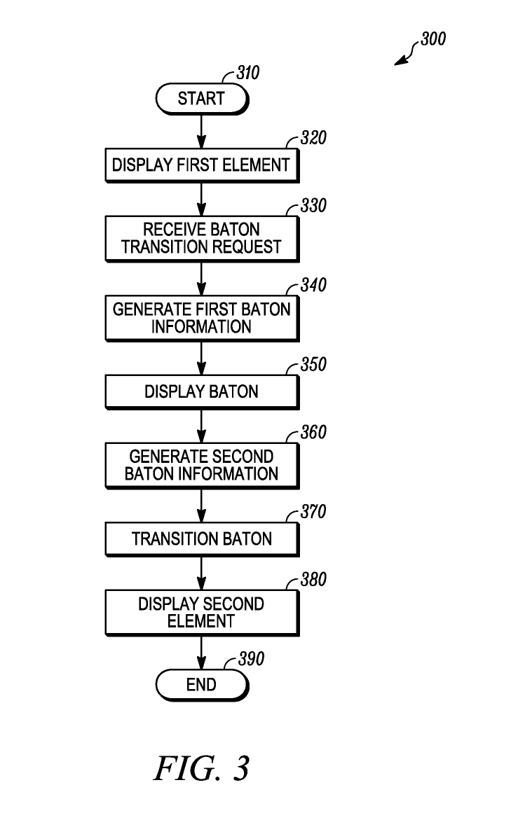

FIG. 3 illustrates a sample flowchart 300 illustrating the operation of a user device, such as the user device 200, according to one embodiment. At 310, the flowchart can begin. At 320, at least one first element can be displayed on a screen. The first element can correspond to a first activity operating in the user device. The first activity can be a first task configured to run on the user device. At 330, a baton transition request can be received. The baton transition request can include first baton image information. The baton transition request can also include source coordinates for the first image corresponding to the first activity baton information.

At 340, first activity baton information can be generated. The first baton information can provide visual transition information for a transition from the first activity to a second activity. The second activity can be configured to operate in the user device. The second activity can be a second task configured to run on the user device. The first activity baton information can include information corresponding to a visual animation for the transition from the first activity to the second activity. The first activity baton information can be generated by generating the first activity baton information based on the first baton image information. The first activity baton information can be generated by generating the first activity baton information based on the source coordinates for the first image. The first activity baton information can be generated by retrieving a first transition policy corresponding to a first visual animation sequence of the first image corresponding to the first activity baton information.

At 350, a first baton image corresponding to the first activity baton information can be displayed. Displaying the first baton image corresponding to the first activity baton information can include displaying the first visual animation sequence of the first baton image. At 360, second activity baton information can be generated. The second activity baton information can provide visual transition information for a transition from the first activity to the second activity. Target coordinates can be received for the second image and the second activity baton information can be generated based on the target coordinates for the second image.

At 370, the first baton image corresponding to the first activity baton information can be transitioned to a second image corresponding to the second activity baton information. Transitioning the first image to the second image can include a continuous transition. Transitioning the first image to the second image can also include a discontinuous transition. For example if a target location of the second image is determined before a first animation sequence of the first image is complete, the method can dismiss the first animation sequence and begin a second animation sequence to the second image target location from where the first animation sequence was dismissed. A second transition policy can be retrieved. The second transition policy can correspond to a visual animation sequence of the second image corresponding to the second activity baton information. The first translation policy and/or the second translation policy can include information corresponding to a visual animation sequence for the transition from the first activity to the second activity.

At 380, the second image corresponding to the second activity baton information can be displayed and at least one second element can be displayed on the screen. The second element can correspond to the second activity operating in the user device. Displaying the second image corresponding to the second activity baton information can include swapping a source baton corresponding with the first activity baton information or corresponding to an animated baton for the transition, with a target baton or with a destination element related to the transition and corresponding to the second activity. Displaying the second image corresponding to the second activity baton information can include displaying the second visual animation sequence of the second image.

At 390, the flowchart 300 can end. The flowchart 300 can be performed by a baton transition service API, by a controller, by hardware, by software, or by any other baton transition service module. An API can be an interface implemented by a software program that enables it to interact with other software. It can facilitate interaction between different software programs similar to the way the user interface facilitates interaction between humans and computers. An API can be implemented by applications, libraries, and operating systems to determine their vocabularies and calling conventions, and can be used to access their services. It may include specifications for routines, data structures, object classes, and protocols used to communicate between the device user and the implementer of the API.

According to some embodiments, all of the blocks of the flowchart 300 are not necessary. Additionally, the flowchart 300 or blocks of the flowchart 300 may be performed numerous times, such as iteratively. For example, the flowchart 300 may loop back from later blocks to earlier blocks. Furthermore, some of the blocks can be performed concurrently or in parallel processes.

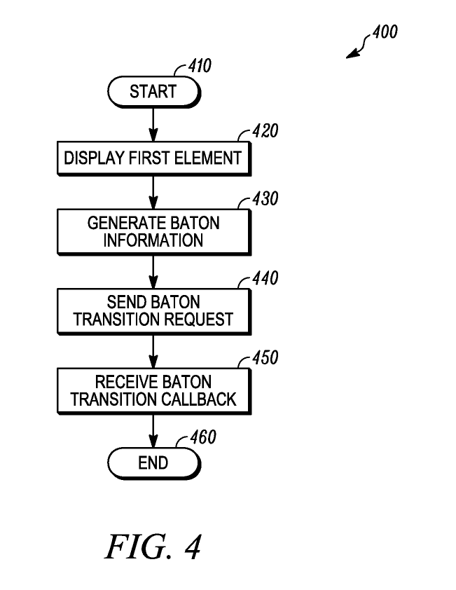

FIG. 4 illustrates a sample flowchart 400 illustrating the operation of a user device, such as the user device 200, according to one embodiment. At 410, the flowchart can begin. At 420, at least one first element can be displayed on a screen. The first element can correspond to a first activity operating in the user device.

At 430, first activity baton information can be generated. The first activity baton information can provide visual transition information for a transition from the first activity to a second activity. The second activity can be configured to operate in the user device. Generating first activity baton information can include creating a baton data structure that provides visual transition information for a transition from the first activity to the second activity. The first activity baton information can include an indicator of the first activity and an indicator of the second activity. The first activity baton information can include information corresponding to views for use for the transition from the first activity to the second activity. The first activity baton information can include source coordinates for displaying first image corresponding to the first activity baton information.

At 440, a baton transition request can be sent to a baton service. The baton transition request can include the first activity baton information. An intent message can also be sent to the second activity. The intent message can indicate an intent to start the second activity. For example, the intent message can indicate an intent to operate the second activity, can include a name of the second activity, and/or can include any other indicator of second activity.

At 450, a baton transition callback can be received from the baton service. The baton transition callback can indicate the initiation of a baton transition in response to the baton transition request. The first element can be hidden on the screen in response to receiving the baton transition callback from the baton service.

At 460, the flowchart 400 can end. The flowchart 400 can be performed by a baton client API, by a controller, by hardware, by software, or by any other baton client module. According to some embodiments, all of the blocks of the flowchart 400 are not necessary. Additionally, the flowchart 400 or blocks of the flowchart 400 may be performed numerous times, such as iteratively. For example, the flowchart 400 may loop back from later blocks to earlier blocks. Furthermore, some of the blocks can be performed concurrently or in parallel processes.

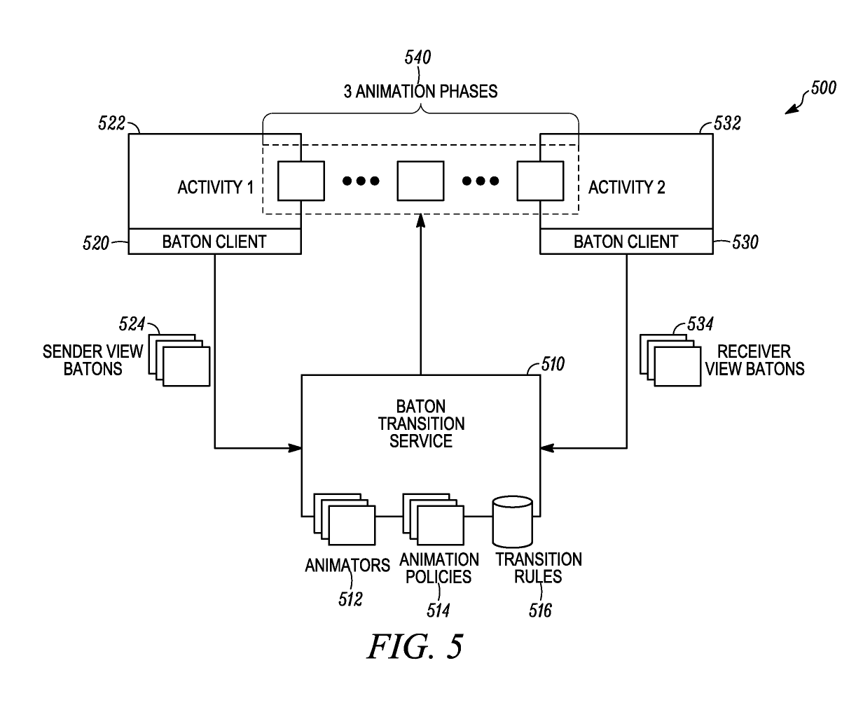

FIG. 5 is an example illustration of a baton framework 500 that accomplishes baton transitions according to one embodiment. The baton framework 500 can include a baton transition service 510. The baton transition service 510 can include or can access animators 512, animation policies 514, and transition rules 516. The baton framework 500 can include at least one baton client 520 and 530 that can correspond to a first activity 522 and a second activity 532, respectively. The baton client 520 can send baton view information 524 to the baton transition service 510. The baton client 530 can send baton view information 534 to the baton transition service 510. The baton view information 524 and 534 and corresponding batons may have different functionality and different corresponding actions than each other.

The baton transition service can generate animation phases 540 for transitioning a baton from the first activity 522 to the second activity 532. The activities 522 and/or 532 can include user interface controls, such as images, tasks, buttons, items on a list, or any other construct that a user can interact with. For example, activities 522 and/or 532 can be screens, views, application screens, displayed controls, and/or tasks.

For example, the baton transition service 510 can handle the transition animation of screen elements or batons between two activities 522 and 532. A baton client 520 and/or 530 can comprise a library that can provide API's for the activities 522 and 532 to easily initiate or receive baton transitions. The library can encapsulate the client logic and can be responsible for all the interactions with the baton transition service 510. The first activity 522 can use the baton client 520 to send pixmaps corresponding to the baton to be used for the transition to the baton transition service 510, and hence can initiate the transition. The first activity's views corresponding to the batons can be hidden as soon as the baton transition service 510 starts the transition. The second activity 532 can use the baton client 530 to send pixmaps and final coordinates of the batons used in the transition to the baton transition service 510. The second activity's views corresponding to the batons can be hidden until the baton transition service 510 completes the transition. As an option, another animation, such as a third phase animation, can be performed to animate the swap of the source and destination batons.

Animation policy classes 514 can define how the batons should be animated. Each animation policy class 514 can dictate all animations used in one transition. A transition may consist of multiple batons animated for three different phases 540. Individual animations within an animation policy class 514 can be specified as operating system classes with an extension to support 3D. The baton transition service 510 can maintain different animator classes 512. The animator classes 512 can be animation engines that execute the animation policies 514. Two animator classes 512 can be supported, one for 2D graphics and another for 3D. The transition rules 516 can define transitions across screens. A single rule can specify a source activity name, a destination activity name, actions, and the name of the animation policy class 514 to use for that transition.

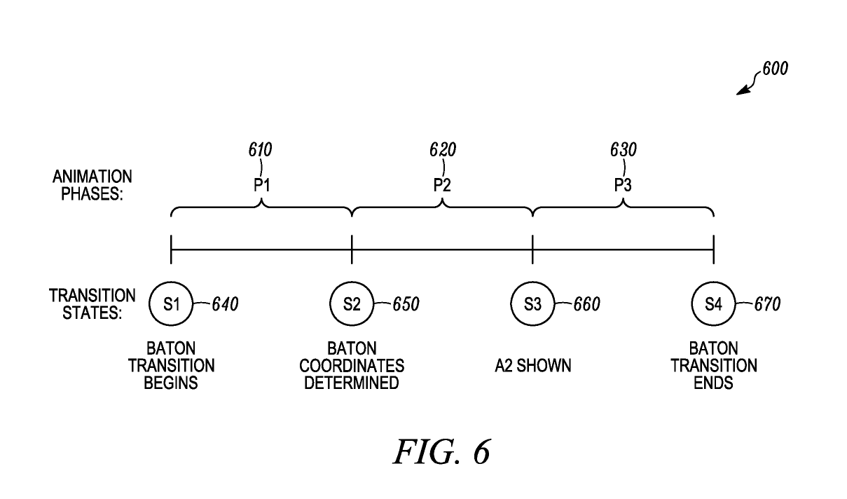

FIG. 6 is an example illustration 600 of transition states and multi-phased baton animations according to one embodiment. The transition states and multi-phased baton animations can address issues when the final target baton positions cannot be determined before the target activity is fully launched. At the first state 640, the baton transition can begin where a first activity initiates transition with a baton transition service to launch a second activity and a first phase 610 animation can begin by animating batons from source locations to some temporary locations defined by the first phase 610 animation. At the second state 650, target baton coordinates can be determined by the second activity, the first phase 610 animation can be dismissed if it is not yet completed, and a second phase 620 animation can begin. The second phase 620 animation can animate batons from their locations when the first phase 610 was dismissed to locations defined by the second phase 620 animation. At the third state 660, the second phase 620 animation can complete by moving the source batons to final destinations, the second activity can be shown, and the third phase 630 animation can be launched to swap the source batons with target batons. At the fourth state 670, the baton transition can complete by ending the third phase 630 animation and by showing final baton target object.

The first phase 610 animation may not complete if the second state 650 comes quickly, such as by quickly determining the locations of the target baton locations. The second phase 620 animation may be allowed to fully complete. The second activity may already be shown at this point, but the target baton objects may be hidden. Any of the animation phases 610, 620, and/or 630 may be programmed to have no animation.

As an example, an animation design can use the first phase 610 to fade in a baton. The baton can remain in place while a first activity is dismissed. Then the second phase 620 animation can be used to move the baton from the source position to the final baton destination on the second activity. The third phase 630 animation can be used to perform a cross-fade to reveal the target baton view.

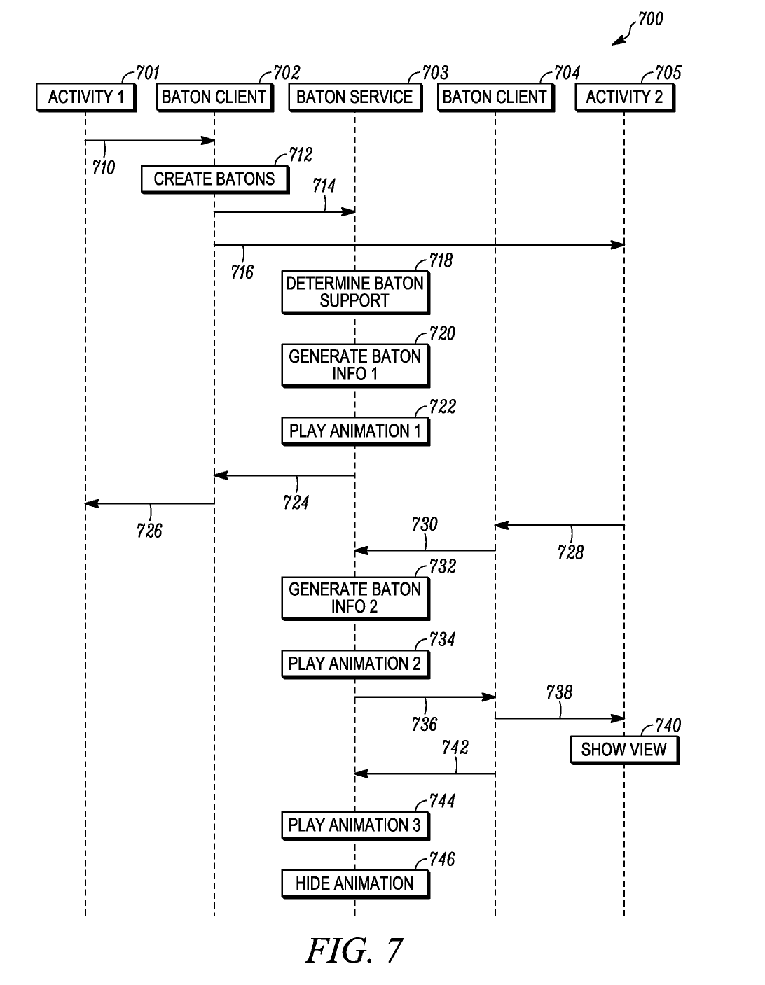

FIG. 7 is an example illustration of a sequence signal flow diagram 700 for a first activity 701, a first baton client 702, a baton transition service 703, a second baton client 704, and a second activity 705 according to one embodiment. The signal flow diagram 700 can depict the flow of baton transition when the first activity 701 launches the second activity 705.

At 710, the baton client 702 can be created by the first activity 701 invoking the baton client 702 API to initiate the baton transition service 703 and by sending the baton transition service 703 all the views that will be animated. At 712, the baton client 702 and/or the first activity 701 can creates baton(s). A corresponding baton data structure can include an intent for the second activity 705, a first activity 701 reference, views to be used in the transition animation, a customized animation class object if any, source coordinates in the first activity 701 window of the view, and the name of the target second activity 705 that supports baton animation. At 714, the first baton client 702 can send a transition request including batons to the baton transition service 703. For example, the first baton client 702 can call a transition animation service 703 API to set the baton(s) to start the three phase transition animation. At 716, the first baton client 702 can send an intent to initiate the start of the second activity 705.

At 718, the baton transition service 703 can determine whether the second activity 705 supports batons. The baton transition service 703 can also look up the transition policy to find the appropriate animation for the baton(s). At 720, the baton transition service 703 can generate first baton information. At 722, the baton transition service 703 can play a first phase animation. At 724, the baton transition service 703 can invoke the first baton client's first phase callback when the first phase animation is done. At 726, a first phase callback function can request the first activity 701 to hide its view.

At 728, the second activity 705 can create the second baton client 704, can send the second baton client 704 the final coordinates for the baton(s), and can hide its view. At 730, the second baton client 704 can connect to the baton transition service 703 and can pass the final coordinates for the baton(s) to be used by the second phase animation. At 732, the baton transition service 703 can generate second baton information. At 734, the baton transition service can start the second phase animation.

At 736, the baton transition service 703 can invoke the second baton client 704 callback when the second phase animation is done. At 738, in the callback, the second baton client 704 can request the second activity 705 to show its view. At 740, the second activity 705 can show its view. At 742, the second baton client 704 can request the baton transition service 703 to start the third phase animation. At 744, the baton transition service 703 can start the third phase animation. At 746, the baton transition service 703 can hide the animation window when the third phase animation is complete.

Embodiments can provide for new kinds of activity, window, and screen transitions, called baton transitions. A baton can be a visual icon that can be maintained on a screen and can be animated across a display as a first activity switches to a second activity. User interface elements and/or controls from source and destination screens can be designated as batons. The batons can become the focal points for user interactions across screens. The batons can help to maintain the context of the interaction for the user and create a story-telling kind of user experience.

Embodiments can provide for a baton framework that can support different kinds of animations that can be applied to the batons. The different animations can include animations in 2D space including alpha, translate, rotate, scale, set grouping, and interpolators, such as acceleration, deceleration, bounce, overshoot, and other interpolators, and other animations in 2D space. The different animations can also include animations in 3D space including translation, rotation, scaling, cropping, background blurring, and other animations in 3D space.

The methods of this disclosure may be implemented on a programmed processor. However, the operations of the embodiments may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the operations of the embodiments may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the embodiments of the disclosure as set forth herein are intended to be illustrative, not limiting. Various changes may be made without departing from the spirit and scope of the disclosure.

In this document, relational terms such as “first,” “second,” and the like may be used solely to distinguish one entity or action from another entity or action without necessarily requiring or implying any actual such relationship or order between such entities or actions. The term “coupled,” unless otherwise modified, implies that elements may be connected together, but does not require a direct connection. For example, elements may be connected through one or more intervening elements. Furthermore, two elements may be coupled by using physical connections between the elements, by using electrical signals between the elements, by using radio frequency signals between the elements, by using optical signals between the elements, by providing functional interaction between the elements, or by otherwise relating two elements together. Also, relational terms, such as “top,” “bottom,” “front,” “back,” “horizontal,” “vertical,” and the like may be used solely to distinguish a spatial orientation of elements relative to each other and without necessarily implying a spatial orientation relative to any other physical coordinate system. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A method in a user device, the method comprising:
displaying at least one first element on a screen, the first element corresponding to a first activity operating in the user device;
generating first activity baton information that provides visual transition information for a transition from the first activity to a second activity, where the second activity is configured to operate in the user device;
displaying a first baton image corresponding to the first activity baton information;
generating second activity baton information that provides visual transition information for a transition from the first activity to the second activity;
transitioning the first baton image corresponding to the first activity baton information to a second image corresponding to the second activity baton information;
displaying the second image corresponding to the second activity baton information; and
displaying at least one second element on the screen, the second element corresponding to the second activity operating in the user device.

2. The method according to claim 1, wherein the first activity baton information includes information corresponding to a visual animation for the transition from a substantially full screen first activity to a substantially full screen second activity.

3. The method according to claim 1, further comprising receiving a baton transition request;
wherein the baton transition request includes first baton image information, and
wherein generating the first activity baton information includes generating the first activity baton information based on the first baton image information.

4. The method according to claim 1, further comprising receiving a baton transition request,
wherein the baton transition request includes source coordinates for the first image corresponding to the first activity baton information.
wherein generating the first activity baton information includes generating the first activity baton information based on the source coordinates for the first image.

5. The method according to claim 1, further comprising retrieving a first transition policy corresponding to a first visual animation sequence of the first image corresponding to the first activity baton information,
wherein displaying the first baton image corresponding to the first activity baton information includes displaying the first visual animation sequence of the first baton image.

6. The method according to claim 1, further comprising receiving target coordinates for the second image,
wherein the second activity baton information is generated based on the target coordinates for the second image.

7. The method according to claim 1, further comprising retrieving a second transition policy corresponding to a visual animation sequence of the second image corresponding to the second activity baton information.

8. The method according to claim 7, wherein displaying a second image corresponding to the second activity baton information includes displaying the second visual animation sequence of the second image.

9. The method according to claim 1,
wherein the first activity comprises a first task configured to run on the user device, and
wherein the second activity comprises a second task configured to run on the user device.

10. A method in a user device comprising:
displaying at least one first element on a screen, the first element corresponding to a first activity operating in the user device;
generating first activity baton information that provides visual transition information for a transition from the first activity to a second activity, where the second activity is configured to operate in the user device;
sending a baton transition request to a baton service, the baton transition request including the first activity baton information; and
receiving a baton transition callback from the baton service, the baton transition callback indicating the initiation of a baton transition in response to the baton transition request.

11. The method according to claim 10, further comprising sending an intent message to the second activity, the intent message indicating an intent to start the second activity.

12. The method according to claim 10, further comprising hiding the first element on the screen in response to receiving the baton transition callback from the baton service.

13. The method according to claim 10, wherein generating first activity baton information comprises creating a baton data structure that provides visual transition information for a transition from the first activity to the second activity.

14. The method according to claim 10, wherein the first activity baton information includes an indicator of the first activity and an indicator of the second activity.

15. The method according to claim 10, wherein the first activity baton information includes information corresponding to views for use for the transition from a substantially full screen first activity to a substantially full screen the second activity.

16. The method according to claim 10, wherein the first activity baton information includes source coordinates for displaying first image corresponding to the first activity baton information.

17. A user device comprising:
a display configured to display at least one first element, the first element corresponding to a substantially full screen first activity operating in the user device; and
a baton transition service module configured to receive a baton transition request and generate first activity baton information that provides visual transition information for a transition from the first activity to a substantially full screen second activity, where the second activity is configured to operate in the user device,
wherein the display is configured to display a first baton image corresponding to the first activity baton information,
wherein the baton transition service module is configured to generate second activity baton information that provides visual transition information for a transition from the first activity to the second activity and configured to provide transition information for transitioning the first baton image corresponding to the first activity baton information to a second image corresponding to the second activity baton information, and
wherein the display is configured to display the second image corresponding to the second activity baton information and configured to display at least one second element, the second element corresponding to the second activity operating in the user device.

18. The user device according to claim 17, wherein the first activity baton information includes information corresponding to a visual animation for the transition from the first activity to the second activity.

19. The user device according to claim 17,
wherein the baton transition request includes first baton image information, and
wherein the baton transition service module is configured to generate the first activity baton information by generating the first activity baton information based on the first baton image information.

20. The user device according to claim 17, wherein the baton transition service module is configured to retrieve a transition policy corresponding to a visual animation sequence of an image corresponding to activity baton information.
